(19) United States
(12) Patent Application Publication
(10) Pub. No.: US 2016/0047084 A1
(43) Pub. Date: Feb. 18, 2016

(54) Sock Clip

(71) Applicant: Jordan Michael Biller, 5158 S. Marquette Ct, WI (US)

(72) Inventor: Jordan Michael Biller, 5158 S. Marquette Ct, WI (US)

(21) Appl. No.: 14/817,176

(22) Filed: Aug. 3, 2015

Related U.S. Application Data
(60) Provisional application No. 62/037,450, filed on Aug. 14, 2014.

(51) Int. Cl. D06F 95/00; A44B 99/00; F16B 2/22; F16B 2/00

(52) U.S. Cl. CPC D06F 95/008; F16B 2/005; A44B 99/00; F16B 2/22

(57) ABSTRACT

The sock clip is a device to be used to hold together two matching socks before, during, and after, prepping, washing, and drying of said socks and any accompanying laundry. It is an easily mass produced device that does not damage the socks or hinder washing ability.

### BACKGROUND OF INVENTION

The sock/garment clip has existed on different levels. Prior designs seem to be cumbersome and large. The intent of this design is to greatly simplify the overall design a such a device. As well as to reduce the size of the device, increase the ease of manufacturing, and in return reduce the cost of manufacturing. The increased simplicity of the design also allows for easy use.

### SUMMARY OF INVENTION

The sock clip is a small device that is to be used to hold together two socks of a matching pair. The sock clip is easily applied to the socks, and does not damage or pierce the sock material when clasped together. The sock clip is attached to the matching socks after use and remains on the sock during washing (in a machine washer) and drying (in a machine dryer). After washing and drying is complete the sock clip is easily removed from the matching socks making sorting easy and eliminating mismatched socks.

### BRIEF DESCRIPTION OF DRAWINGS:

FIG. 1: Broken/partial front view of the sock clip shows the clearance between overlapping parts of the helix allowing the part to be easily molded in plastic.

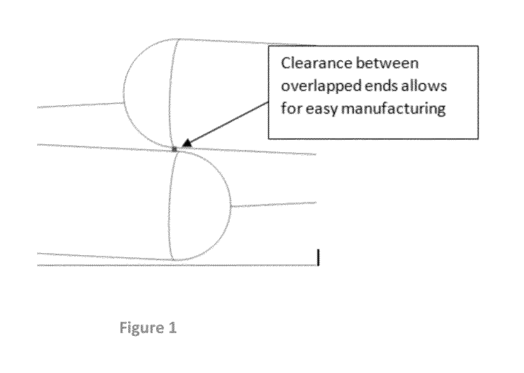

FIG. 2: Front view with an illustration depicting how the direction of the helix can be flipped from its resting position to “position 2” as shown in the illustration. The second position provides more clamping tension for socks made up of thinner material or socks that do not have a hemmed/thicker brim around the top portion of the sock. The second position is also helpful for longer socks than may be more prone to catching on other garments before, during, and after washing.

FIG. 3: Illustration depicting best/easiest mode of operation for the clasp 1. The sock clip is firmly grasped 180 degrees opposite the overlapped portion of the helix. In the opposite hand two matching socks are held with the openings lined up and held together. The overlapping portion of the helix is then clasped over two touching layers of the socks as seen. *Illustration is not to any particular scale.

### DETAILED DESCRIPTION OF INVENTION

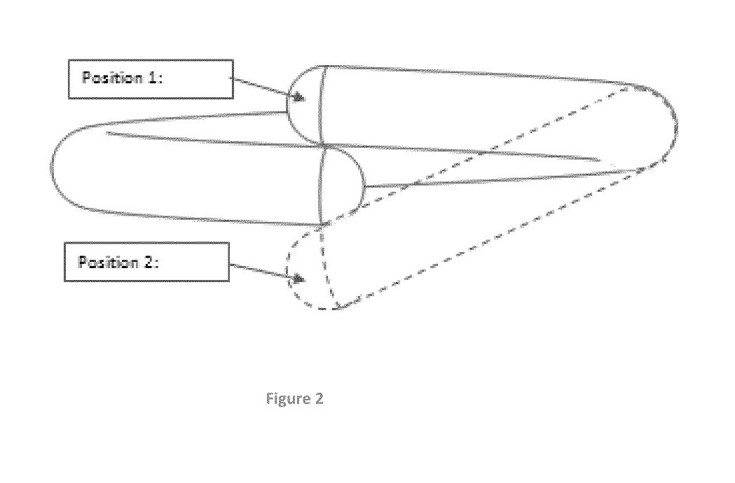

The sock clip is a small easily manufactured device intended to hold together two socks of a matching pair during the washing and drying process. The helical design of the sock clip allows the device to be easily produced as a single injection molded part, as well as provides the necessary tension to hold the two socks together during washing and drying of the laundry. The clasp 1, while simple, allows for two clasping tensions, the standard position clasping tension, and the second position for higher clasping tension as depicted in FIG. 2.

Production of Clasp 1: The sock clip is to be injection molded as a single piece. A plastic with medium temperature range (maximum temperatures experienced during washing and drying of laundry by any typical means) and reasonable tensile strength is to be used in production. Varying surface finishes and/or coatings may be applied to the sock clip in order to provide desired grip, touch, aesthetic appeal, and wear resistance.

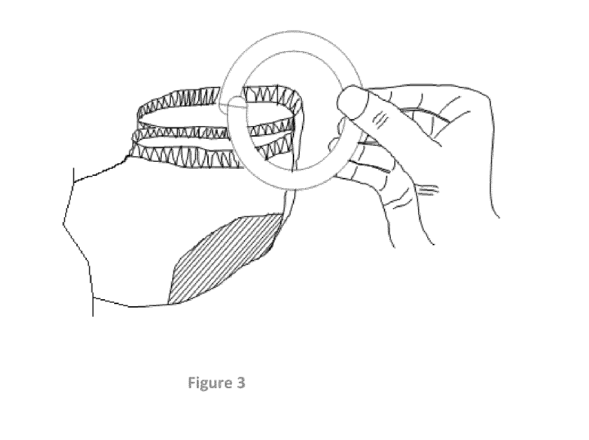

Mode of Operation: The best/easiest mode of operation of the sock clip can be seen in FIG. 3. For longer socks try clasping the socks at the heel through all layers of the two socks to ensure they will not separate while washing and drying of the socks. As mentioned in the first portion of the detailed description and as seen in FIG. 2 the sock clip has two tensions. For socks that may require a higher clasping tension in order to remain together during washing and drying the second position depicted in FIG. 2 allows the sock clip more firmly grip the pair of socks.

1. I claim a device to be used to hold two socks together before, during, and after preparing, washing, and drying of the socks and any accompanying laundry.

2. I claim any helical-like ring device that is to be used to hold two socks together before, during, and after preparing, washing, and drying by any typical means of the socks and any accompanying laundry.

3. I claim any helical device as in claim 2, comprising of a single part.

4. I claim any helical device as in claims 1 and 2, which has two unique tension positions.

5. I claim a helical, single part injection molded device, capable of two unique tensions, with specified surface-finish and or coating to be used to hold two socks together before, during, and after preparing, washing, and drying by any typical means of the socks and any accompanying laundry.
